(19) United States
(12) Patent Application Publication
(10) Pub. No.: US 2015/0067057 A1
(43) Pub. Date: Mar. 5, 2015

(54) SYSTEM AND METHOD FOR STREAMLINING MICROBLOGS ACROSS A PLURALITY OF MEDIA CHANNELS

(71) Applicant: Meddle, Inc., Atlantic Highlands, NJ (US)

(72) Inventors: Vidar BREKKE, Atlantic Highlands, NJ (US); Balaram KOMMIREDDI, HOLMDEL, NJ (US)

(73) Assignee: Meddle, Inc., Atlantic Highlands, NJ (US)

(21) Appl. No.: 14/471,639

(22) Filed: Aug. 28, 2014

Related U.S. Application Data
(60) Provisional application No. 61/871,340, filed on Aug. 29, 2013.

(51) Int. Cl. H04L 29/08

(52) U.S. Cl. CPC H04L 67/104; H04L 67/02
USPC 709/204

(57) ABSTRACT

A system and method for streamlining microblogging across a plurality of media channels are provided. The method includes receiving content to be published and a plurality of target media channels; obtaining requirements data comprising at least one requirement respective of each of the plurality of target media channels; for each of the plurality of target media channels determining if the content successfully meets the at least one requirement of the target media channel; generating a set of characterization attributes to optimize the content reach through the target media channel compiling a microblog and metadata respective of the set of characterization attributes for the target media channel; and sending the metadata and the microblog to the target media channel.

### CROSS-REFERENCE TO RELATED APPLICATIONS

This application claims the benefit of U.S. provisional application No. 61/871,340 filed on Aug. 29, 2013, the contents of which are herein incorporated by reference.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to social media and microblogging and, more particularly, to easy and efficient creation of micro-blogs for sharing on social media networks.

### BACKGROUND

Social media networks enable their users to post content and to consume content posted by other users. Posted content is typically in forms such as text, audio, images, videos, and combinations thereof. Social media networks also offer microblogging services that have become popular over the past few years. Such services allow a user to enter short messages (microblogs) about what they are doing at that moment or, more generally, a comment, a question, or a thought they may have. These short messages are then publicly available to the user's ‘followers’ who have expressed an interest in the user's microblogs. That is, through the use of a microblogging service, a user may post a message via the Internet. Similarly, when a user finds a message posted by another user interesting, the user may repost the message. Various social media services may also allow users to post one or more pictures, videos, or other pieces of multimedia content to be shared in place of or in addition to short messages.

Microblogging services can be general-purpose or can be related to a specific topic or service. An example of a microblogging service centered on a specific topic would be a microblogging service centered on a sports team, where users (or ‘followers’) can comment with their opinions and thoughts about the sports team. Examples of microblogging services include social networks, such as Facebook®, Instagram®, or Twitter®, as well as instant messaging.

The web in general, and social networks in particular, has become a popular marketing tool. In the social networking arena there are generally two groups of users: followers, and influencers who try to shape the opinion of the followers. An influencer posts microblogs very frequently in a specific topic that is of interest to his or her followers. Because microblogs are typically short and therefore quick to create, they are popular publishing tools for, e.g., influencers who want to provide a high frequency of content as a way to stay top of mind with their followers. Typically, influencers often post microblogs to build credibility for their reputation, products, and/or services. For example, a patent attorney would microblog about IP-law related news and topics to build credibility for his or her firm.

Currently, to write a microblog, the blogger should come up with a topic of interest and create the content of the blog (including such text, images, videos, or combinations thereof that are appropriate) and individually post the microblog to each media channel (e.g., a web site, a social networking site, and so on).

In the related art, various solutions for publishing a piece of content to multiple social networks are available. Such solutions publish identical content to every designated network. This is a limiting factor, as all networks are different in nature. For example, LinkedIn® is business-oriented, while Facebook® is not, and each one has unique restrictions for posting or otherwise publishing content. Thus, posting the same content on multiple networks simultaneously may result in lack of interest to the users of one or more of the networks.

It would be therefore advantageous to provide a microblogging solution that would overcome the deficiencies noted above.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor to delineate the scope of any or all embodiments. Its sole purpose is to present some concepts of one or more embodiments in a simplified form as a prelude to the more detailed description provided further herein below. For convenience, the term some aspects may be used herein to refer to a single aspect or to multiple aspects of the disclosure.

The disclosure relates in various embodiments to a system and method for streamlining microblogging across a plurality of media channels. The method comprises receiving content to be published and a plurality of target media channels; obtaining requirements data comprising at least one requirement respective of each of the plurality of target media channels; for each of the plurality of target media channels determining if the content successfully meets the at least one requirement of the target media channel; generating a set of characterization attributes to optimize the content reach through the target media channel compiling a microblog and metadata respective of the set of characterization attributes for the target media channel; and sending the metadata and the microblog to the target media channel

The system comprises a processing system; and a memory communicatively connected to the processing system, the memory containing instructions that, when executed by the processing system, configure the system to: receive content to be published and a plurality of target media channels; obtain requirements data comprising at least one requirement respective of each of the plurality of target media channels; for each of the plurality of target media channels: determine if the content successfully meets the at least one requirement of the target media channel; generate a set of characterization attributes to optimize the content reach through the target media channel; compile a microblog and metadata respective of the set of characterization attributes for the target media channel; and send the metadata and the microblog to the target media channel.

### BRIEF DESCRIPTION OF THE DRAWINGS

The subject matter that of the disclosed embodiments is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a network system utilized to describe the various disclosed embodiments.

FIG. 2 is a flowchart describing a method for creating and distributing a microblog according to one embodiment.

FIG. 3 is a schematic block diagram of an editor server according to one embodiment.

FIGS. 4A-4D are screenshots illustrating creating and publishing a microblog according to an embodiment.

FIG. 5 is a screenshot for generating a microblog from a video transcript according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

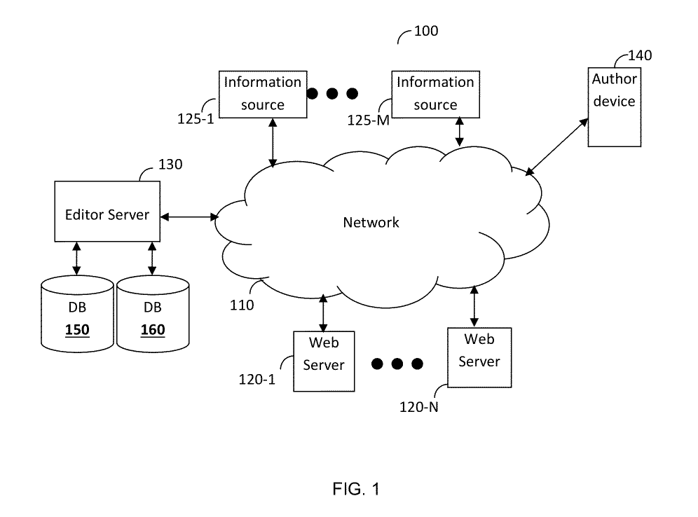

FIG. 1 shows an exemplary and non-limiting schematic diagram of a network system 100 utilized to describe the various disclosed embodiments. The system includes a network 110, a plurality of web servers 120-1 through 120-N (hereinafter referred to collectively as web servers 120 or individually as a web server 120, merely for simplicity purposes), a plurality of information sources 125-1 through 125-M (hereinafter referred to collectively as information sources 125 and individually as an information source 125, merely for simplicity purposes) connected to the network 110, an editor server 130, an author device 140, a provisions database (DB) 150, and a content DB 160.

The network 110 may be any combination of wired and/or wireless network including, but not limited to, a local area network, a wide area network (WAN), a metropolitan area network (MAN), the Internet, and the like. A web server 120 may host a media channel for publishing the microblog or the microblog's metadata. The media channel may be, but is not limited to, a web site, a social networking site, and the like. The information source 125 may include, but is not limited to, a web site, a video streaming server, a social networking web site, and so on. An information source 125 may be implemented as or in one of the web servers 120 and the separation between these elements is provided merely for the sake of simplicity of the description.

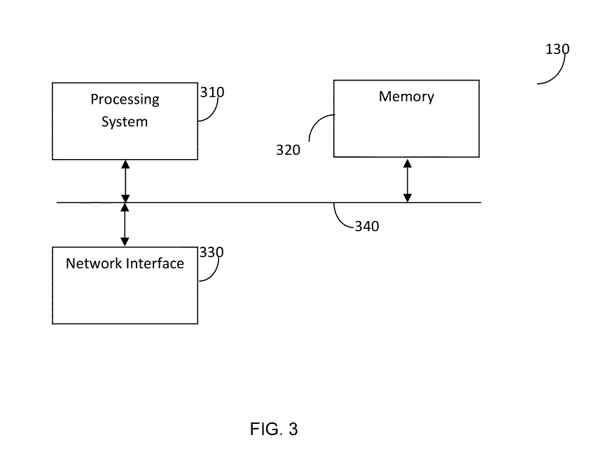

The editor server 130 is configured to allow a user of the author device 140 to provide a piece of content and to distribute the provided content to the web servers 120 for publication thereon. The piece of content may include text, images, video, audio, or any combination thereof. In some implementations, the microblog contents and the metadata are combined. Such a piece of content is hereinafter referred to as a “microblog.” The various embodiments performed by the editor server 130 are disclosed in greater detail herein below with respect to FIG. 3.

The author device 140 may be a personal computer, a tablet computer, a smartphone, and the like. The provisions database 150 is configured with a set of provisions needed to take into consideration when publishing or otherwise posting microblogs on the media channels hosted by the web server 120. Each media channel, and specifically each social network, defines certain requirements for publishing content thereon. As an example, Twitter® limits a tweet to 140 characters. In an embodiment, the provisions database 150 may also include login credentials to access accounts of users utilizing the editor server 130 and a list of social connections (e.g., friends, followers, and so on). A content database 160 is configured to store at least microblogs created by a user of the device 140 and metadata generated respective of such microblogs.

A user seeking to create and publish a microblog on one or more media channels activates a call function from the author device 140. Such a user seeking to publish a microblog is referred to hereinafter as an author, merely for simplicity purposes. The call function is typically activated via an interface (not shown) of the author device 140. Upon activation of the call function, the author device 140 sends a request to the editor server 130 to create a microblog.

In response to the received request, the editor server 130 is configured to prompt the author to enter the text and/or multimedia items to be included in the microblog. In addition, the editor server 130 may prompt the user to select media channels to distribute the microblog to. For each selected media channel, a set of content characterization attributes can be provided, through computerized content analysis or manually by the user, to optimize the impact of the microblog in that respective media channel. Such characterization attributes may include, for example, tags, hashtags describing contents, topics, content descriptions, and so on. Alternatively or collectively, the user may be prompted to include a specific list of social connections or contacts to distribute the microblog to. In one embodiment, the editor server 130 is configured with a default media channel to publish the microblog to. An example for such a default media channel is a personal web page.

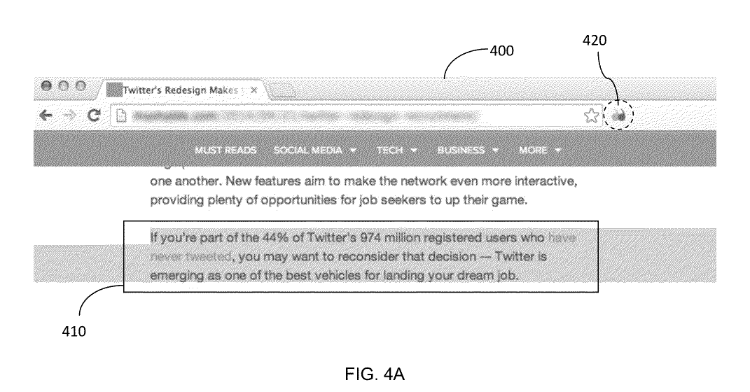

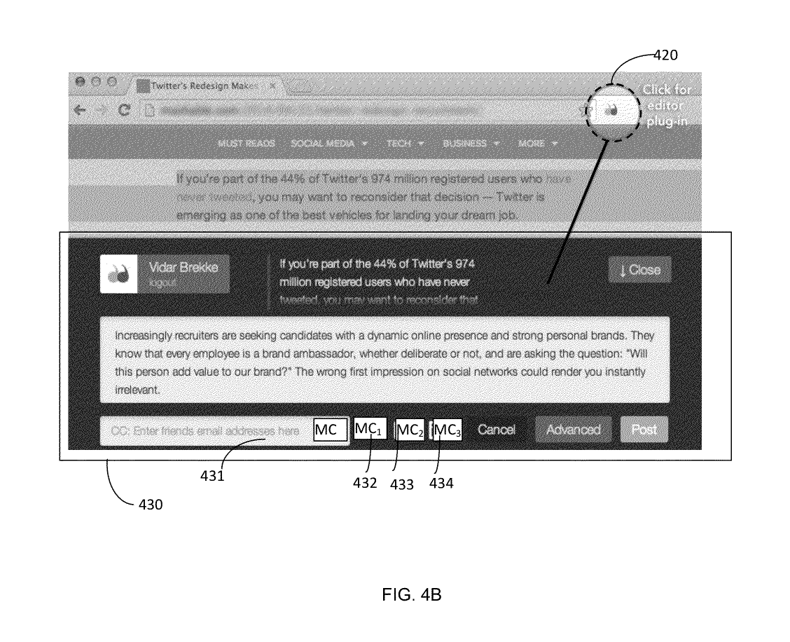

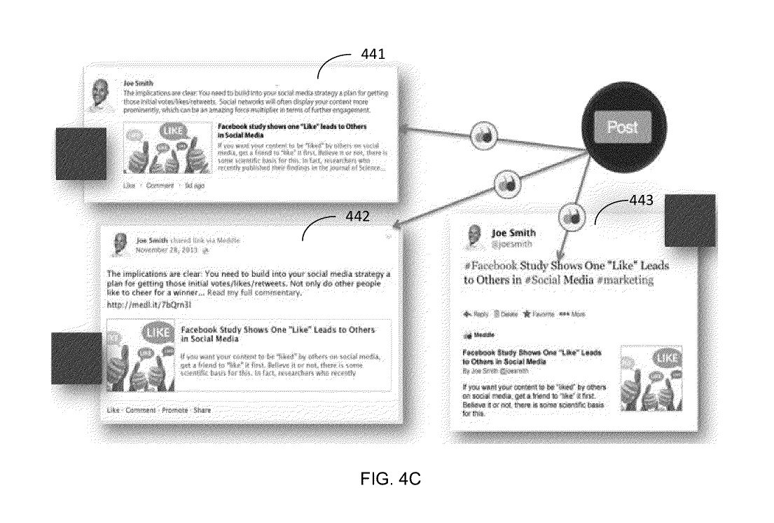

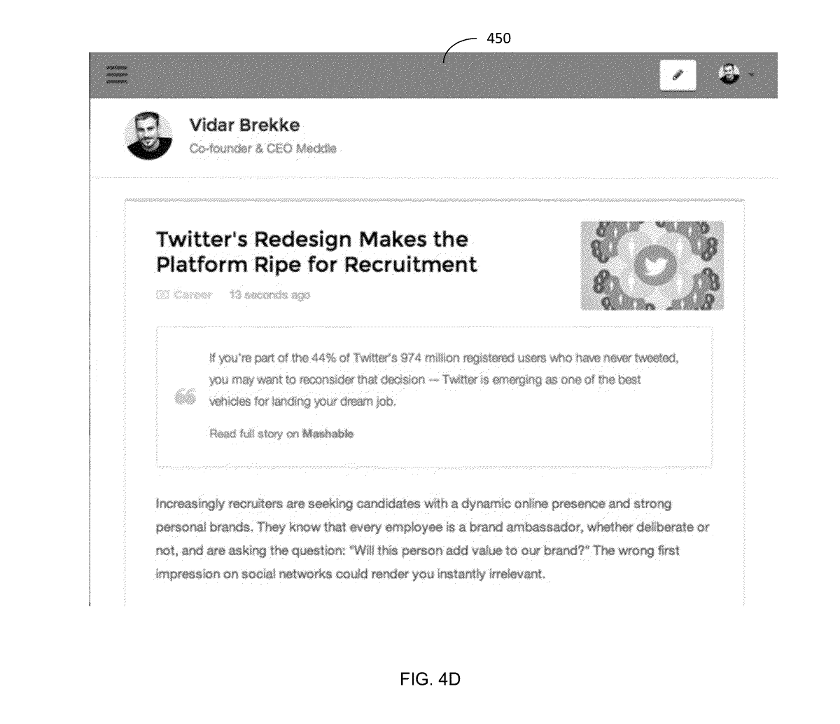

In one embodiment, the text and/or multimedia items to be included in the microblog are provided from an excerpt taken from any source of information such as the information sources 125, the content database 160, or any content (e.g., documents, presentations, multimedia content, and so on) locally saved in the author device 140. For example, the excerpt may be derived from a web page, a video clip, an on-line article, and the likes that the user is currently viewing on the author device 140. The author may enter an excerpt by selecting a piece of information (e.g., a word, a sentence, an image, and so on) presented in a web page or any other type of document that the user is currently viewing. In a non-limiting embodiment, discussed in more detail below, the excerpt can be derived from a video transcript. It should be noted that, in some implementations, the call function for the editor server 130 can be activated after selection of the excerpt. A non-limiting example for such an implementation is described further herein below with reference to FIGS. 4A-4D.

The editor server 130 receives the information entered by the author on the author device 140. Then, based on the input information, the editor server 130 compiles the microblog's contents and generates metadata for each media channel the microblog should be published to. That is, for each selected media channel, a different version of a microblog content and metadata is generated. In some implementations, the microblog contents and the metadata are combined.

To this end, the editor server 130 queries the provisions database 150 to retrieve the requirements associated with each of the selected media channels. The editor server 130 is further configured to check if the retrieved provisions are met by the information provided by the user with respect to the microblog and to the requirements of each of the selected media channels.

In an exemplary embodiment, for each media channel, it is checked if the author has an account or a permission to publish to the media channel. Another check may include if the length and/or size of the content to be published is supported by the respective media channel. For example, if the length of the excerpt and the annotations is more than 140 characters, the microblog generated therefrom cannot be published on Twitter®.

In another embodiment, respective of each selected media channel, a set of microblog characterization attributes is generated. Such attributes may include, for example, tags, hashtags, topics, content descriptions, key words, and so on. The generation of such attributes is performed based in part on computerized textual analysis of the excerpt, annotations, or any textual information provided by the user. The textual analysis accounts for the target media channel while providing characterization attributes. That is, for each selected media channel, a set of characterization attributes may be generated. As a non-limiting example, for the same input excerpt, a different set of characterization attributes may be generated for Facebook® and Linked In® after accounting for the different natures and uses of these media channels.

In an embodiment, the textual analysis may also account for any content characterizations provided by the user to provide a set of characterization attributes that best fit the target media channel.

Based on the various performed checks, the editor server 130 is configured to compile the microblog contents and to generate the metadata associated with such contents. Specifically, for each media channel, the generated metadata includes at least a user name of the author of the content and the author's log-in information, a list of social connections that should gain access to the microblog, a set of restrictions on the published information (e.g., no limitations, limitations on who can view/edit/re-share microblogs or contents therein, and so on), a location identifier (e.g., a URL) of the web server 120 corresponding to the media channel, and/or the characterization attributes.

In an exemplary and non-limiting embodiment, the compilation (creation) of the content may include formatting the received content into a format that matches the target media channel. For example, the editor channel 130 may arrange the content (e.g., by arranging text with respect to images), change a font type, size, and/or color of text, and so on. In another embodiment, the compilation of the content includes extracting and providing a URL of the source of the excerpt, including a name of the author, a picture of the author, and the like. The author's information may be retrieved from the provisions database 150 and may be different for each media channel (e.g., the author name as displayed on Facebook may be different from the author name as displayed on LinkedIn). Some examples for the compilation of the microblog are provided below.

In another embodiment, the compilation (creation) of the microblog includes modifying the received content to meet the provisions of each media channel. For example, the server 130 may cut the excerpt to 140 characters to meet Twitter's text length limitation. Alternatively or collectively, the server 130 may send to the author device 140 instructions as to the required modifications to the contents.

Once the contents of the microblog and the metadata are ready, the editor server 130 establishes a connection with web servers 120 of the respective media channels on which the microblog should be published. Then, the microblog and the respective metadata are sent to each connected web server 120. In an embodiment, the created microblog and metadata are saved in the content database 160.

According to another embodiment, the microblogs can be created by annotating excerpts from video and audio transcribed content. This enables an author to call attention to specific parts of a video or audio content by annotating the transcribed text of such content.

To generate such a microblog, a transcript of video/audio content is provided. Such a transcript may be provided by an agent (not shown) installed on the author device 140, the editor server 130, or an external system (not shown) configured to generate transcripts. In an embodiment, the editor server 130 includes a transcript engine (not shown) configured to receive, from the author device 140, a URL or a content ID of the video/audio content and generate a transcript respective thereof. The generated transcript is displayed on the author device 140.

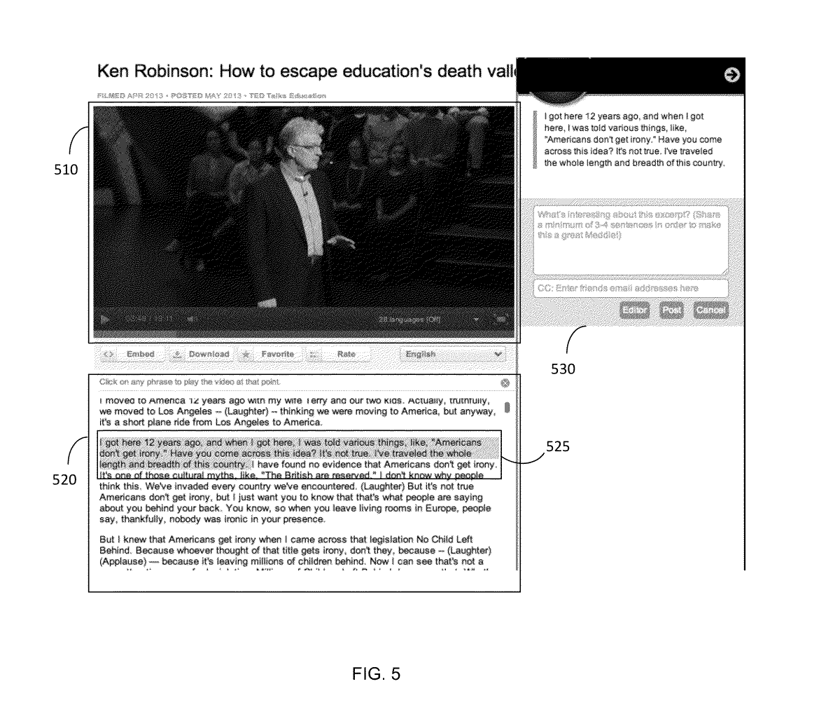

The user is prompted to select parts of the received transcript, to annotate the selected part, and to select one or more media channels to publish the microblog on. This information is sent to the editor server 130, which compiles the microblog and the respective metadata as discussed above. In this embodiment, the annotated transcript is treated and the microblog is published along with a reference (e.g., a hyperlink) back to the video/audio content from which the excerpt originates. A non-limiting example for a microblog based on an annotated transcript is provided herein below with respect to FIG. 5.

Following are a few non-limiting example for the operation of the editor server 130 for generating microblogs posted on Twitter and Facebook. When publishing a microblog on Twitter, the server is configured to automatically add any hashtag presented in the received content, and to truncate the tweet to conform to the maximum character limit of Twitter or any other smaller, pre-determined character length in the event the maximum characters allowed for any reason is found to be non-optimal, thereby modifying the received excerpt to be included in a Twitter summary. The Twitter summary is a feature on Twitter.com where users who view a tweet (microblog) can ‘expand’ the tweet to see more information about its content.

Facebook and LinkedIn posts are also automatically optimized for their respective networks. For both networks, the editor server 130 is configured to auto-optimize and truncate the comments and excerpts to match the maximum text length allowed by each network, or any other smaller, pre-determined character length in the event the maximum characters allowed for any reason is found to be non-optimal. It should be appreciated that, in the disclosed embodiments, any configurable parameter related to the microblog can be optimized respective of the target media channel, e.g., the social networks.

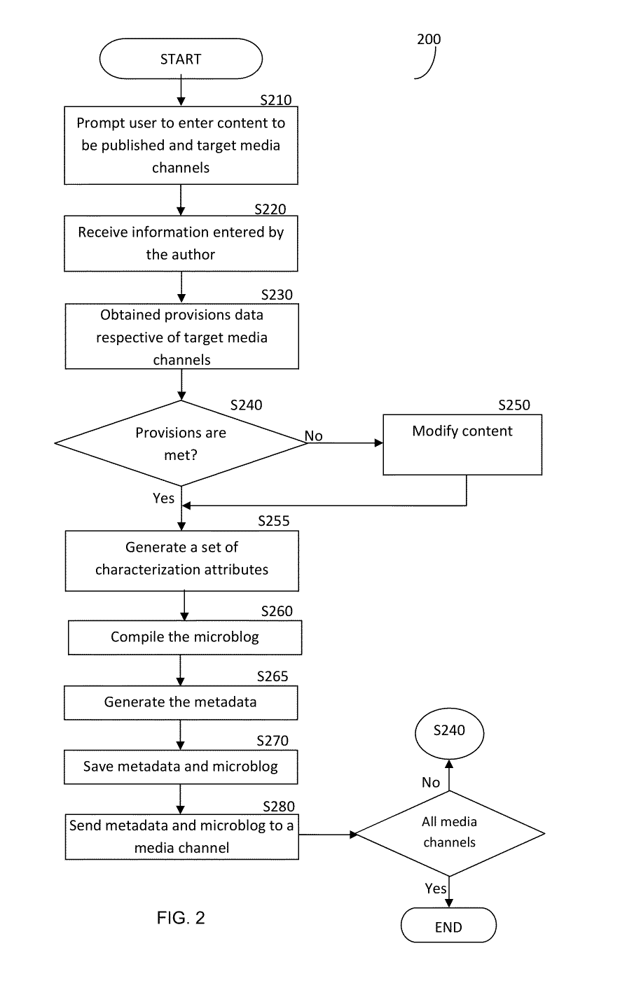

FIG. 2 shows an exemplary and non-limiting flowchart 200 describing a method for creating and distributing a microblog according to one embodiment. At S210, a user is prompted to enter the content to be published and the target media channels. The content may be in a form of text, images, video, audio, combinations thereof, and so on. In an embodiment, the input content may be a content excerpt selected from any information source. An excerpt can be derived, for example, from a web page that the user views, from an on-line article, from posts of other users in the social networks, from a document locally saved in the author device, and so on. In a preferred embodiment, an excerpt may be a transcript of video and/or audio content.

The author is also requested to designate at least one media channel to distribute the microblog to. The media channel may be a web page, a social network, a mailing list, and so on. In an embodiment, for each designated media channel, a set of content characterization attributes are input by the user. At S220, the information entered by the author is received.

At S230, provisions data associated with each media channel designated in S210 is obtained. As noted above, such information may be saved in a database (such as, e.g., the provisions database 150).

At S240, for each media channel, it is checked if the content provided by the user complies with the requirements set for that media channel. If so, execution continues with S255; otherwise, execution continues with S250. Various non-limiting embodiments for possible checks performed at S240 are discussed further herein above. In S250, an attempt to modify the provided content to meet the requirements of each respective media channel is made. Non limiting examples for possible content modifications are described further herein above with respect to FIG. 1. In an exemplary embodiment, if an attempt to modify the content has failed, an error message is sent to the author device with instructions to correct the deficiencies.

At S255, a set of microblog characterization attributes is generated. Such attributes may include, but are not limited to, tags, hashtags, topics, content descriptions, key words, and so on. As noted above, the generation of such attributes is performed based in part on computerized textual analysis of the excerpt, annotations, or any textual information provided by the user. The textual analysis accounts for the target media channel while providing characterization attributes. In an embodiment, the textual analysis may also account for any content characterizations provided by the user (e.g., at S210) to provide a set of characterization attributes that best fit the target media channel.

At S260, the microblog is compiled to include either the content provided by the user or the content modified in S250. Non limiting examples for compilation of the microblog contents are described further herein above with respect to FIG. 1. At S265, metadata respective of the media channel is generated. The generated metadata may include for each media channel, for example, any of: a user name of the author of the content, the author's log-in information, a list of social connections that should gain access to the microblog, a set of restrictions on the published information (e.g., no limitations, limitations on who can view/edit/re-share, and so on), a web address (e.g., a URL) of the web server corresponding to the media channel, characterization attributes, and so on. In certain embodiments, microblog contents and the metadata are combined into the metadata. This would improve the search engine optimization of a web page. In certain embodiments the metadata can also be included into the microblog's graphical user interface itself, e.g., when the metadata represents certain topics, as a way to improve the content navigation.

At S270, the microblog and the created metadata are saved in a storage (e.g., the content database 160) for future use. At S280, a connection is established with a web server hosting the media channel and the microblog and the metadata are sent to the web server. As a result, the web server publishes the microblog according to the preferences set in the metadata.

At S290, it is checked if all media channels designated in S210s have been handled. If so, execution terminates; otherwise, execution returns to S240.

FIG. 3 shows an exemplary and non-limiting schematic block diagram of the editor server 130 according to one embodiment. A processing system 310 is connected to a memory 320 via a bus 340. The memory 320 may comprise volatile and/or non-volatile memory components including, but not limited to, static random access memory (SRAM), dynamic random access memory (DRAM), Flash memory, magnetic memory, and other tangible media on which data and/or instructions may be stored. The process system 310 may include one or more processors, or may be structured as an ASIC or a programmable processor.

A network interface 330 allowing for bidirectional communication between the editor server 130 and other components accessing the network 120 is further connected to the bus 340. The memory 320 may contain instructions that, when executed by the processing system 310, performs, for example and without limitation, creation and publication of microblogs as described in further detail herein.

FIGS. 4A through 4D are exemplary and non-limiting screenshots illustrating creation and publication of a microblog according to the disclosed embodiments.

Referring to FIG. 4A, where a portion of a web page 400 displayed on a user web browser is shown. The user selects a content excerpt 410 and selects a call function 420 that calls the server 130 to open a prompt window. In an embodiment, the selection may be made by clicking on the call function 420.

Referring now to FIG. 4B, where a prompt window 430 is displayed over the web page 400. The prompt window 430 allows the user to annotate the excerpt and select any of the media channels (MC) 431, 432, 433, and 434 to publish the excerpt and the annotations. Upon selection of one or more channels for posting the content, the information provided in the prompt window 430 is received and the microblog and its metadata are compiled as discussed in detail herein above.

Referring now to FIG. 4C, where the publication of the created microblogs 441, 442, and 443 on the social networks (media channels) LinkedIn®, Facebook®, and Twitter®, respectively, are shown. Each microblog may be formatted differently. FIG. 4D shows a publication of the microblog on the author's web page 450. It should be noted that such web page publication channel is typically set as a default channel for publication.

FIG. 5 shows an exemplary and non-limiting screenshot for generating a microblog from a video transcript. A video clip 510 is played and transcripts 520 of the video clip 510 are displayed on the same web page as the video. A user's selection of an excerpt 525 from the transcripts 520 opens a prompt window 530 on the web page (not shown). This would allow the user to annotate the excerpt 525 and to select the media channel to publish the microblog.

The disclosed embodiments may be implemented as hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some embodiments computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some embodiments computer-readable medium may comprise transitory computer readable medium (e.g., comprising a signal). Combinations of the above should also be included within the scope of computer-readable media. It should be appreciated that a computer-readable medium may be implemented in any suitable computer-program product. Although particular embodiments are described herein, many variations and permutations of these embodiments fall within the scope of the disclosure.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

Although some benefits and advantages of the preferred embodiments are mentioned, the scope of the disclosure is not intended to be limited to particular benefits, uses, or objectives. Rather, embodiments of the disclosure are intended to be broadly applicable to different wireless technologies, system configurations, networks, and transmission protocols, some of which are illustrated by way of example in the figures and in the description.

What is claimed is:

1. A method for streamlining microblogging across a plurality of media channels, comprising:
receiving content to be published and a plurality of target media channels;
obtaining requirements data comprising at least one requirement respective of each of the plurality of target media channels;
for each of the plurality of target media channels:
determining if the content successfully meets the at least one requirement of the target media channel;
generating a set of characterization attributes to optimize the content reach through the target media channel;
compiling a microblog and metadata respective of the set of characterization attributes for the target media channel; and
sending the metadata and the microblog to the target media channel.

2. The method of claim 1, wherein receiving content to be published further comprising:
receiving the plurality of media channels to publish the microblog on.

3. The method of claim 2, wherein each of the plurality of media channels includes any of: a social media site, and a web site.

4. The method of claim 1, wherein the content includes a content excerpt derived from online textual information.

5. The method of claim 1, wherein the content includes a content excerpt derived from online audio/video information.

6. The method of claim 4, wherein the content includes annotations of the content excerpt.

7. The method of claim 1, wherein determining if the content successfully meets the at least one requirement of the target media channel further comprising:
modifying the content to meet the at least one requirement of the target media channel.

8. The method of claim 1, wherein the metadata includes at least one of: a user name with the target media channel of the author of the content, a list of social connections, a set of restrictions on the published microblog, a web address of the web server corresponding to the media channel, and characterization attributes.

9. The method of claim 8, wherein compiling the microblog further comprising:
formatting the content to meet preferences of the target media channel.

10. A non-transitory computer readable medium having stored thereon instructions for causing one or more processing units to execute the method according to claim 1.

11. A system for providing a suitable web address to a user device, comprising:
a processing system; and
a memory communicatively connected to the processing system, the memory containing instructions that, when executed by the processing system, configure the system to:
receive content to be published and a plurality of target media channels;
obtain requirements data comprising at least one requirement respective of each of the plurality of target media channels;
for each of the plurality of target media channels:
determine if the content successfully meets the at least one requirement of the target media channel;
generate a set of characterization attributes to optimize the content reach through the target media channel;
compile a microblog and metadata respective of the set of characterization attributes for the target media channel; and
send the metadata and the microblog to the target media channel.

12. The system of claim 11, further configured to:
receive the plurality of media channels to publish the microblog on.

13. The system of claim 12, wherein each of the plurality of media channels includes any of: a social media site, and a web site.

14. The system of claim 11, wherein the content includes a content excerpt derived from online textual information.

15. The system of claim 11, wherein the content includes a content excerpt derived from online audio/video information.

16. The system of claim 14, wherein the content includes annotations of the content excerpt.

17. The system of claim 11, wherein the system is further configured to:
modify the content to meet the requirements of the target media channel.

18. The system of claim 11, wherein the metadata includes at least one of: a user name with the target media channel of the author of the content, a list of social connections, a set of restrictions on the published microblog, a web address of the web server corresponding to the media channel, and characterization attributes.

19. The system of claim 18, wherein the system is further configured to:
format the content to meet preferences of the target media channel.
